(19) United States
(12) Patent Application Publication
(10) Pub. No.: US 2012/0215683 A1
(43) Pub. Date: Aug. 23, 2012

(54) Transaction Processing And Backup

(75) Inventors: J. Mark Miller, Richmond, VA (US); Peter Charles Moir, London (GB); Frank LeRoy Gaudios, Jacksonville, FL (US); Gary Lynn Hartley, Plano, TX (US); Dawn Renee James, Norfolk, VA (US); Stephen Charles McAuliffe, London (GB); Cheryl Lynne Lowrey, Virginia Beach, VA (US)

(73) Assignee: BANK OF AMERICA CORPORATION, Charlotte, NC (US)

(21) Appl. No.: 13/102,086

(22) Filed: May 6, 2011

Related U.S. Application Data
(60) Provisional application No. 61/444,234, filed on Feb. 18, 2011.

(51) Int. Cl. G06Q 40/00

(52) U.S. Cl. 705/39

(57) ABSTRACT

A system and method of providing uninterrupted transaction processing in the event of a failure or outage at a data center is provided. In some examples, the system or method may include receiving a request for a transaction. In some arrangements, a primary data center for processing that transaction may be identified. If the primary data center is available to process the transaction, the transaction may be processed and data associated with the processed transaction may be transmitted to one or more alternate or secondary data centers. If the primary data center is not available, the transaction may be routed to a secondary data center and processed at that data center. Data associated with the processed transaction may then be transmitted to the primary data center and any other secondary data centers. Accordingly, accurate, near real-time transaction data may be maintained at multiple data centers to permit transaction processing at multiple data centers.

### CROSS REFERENCE TO RELATED APPLICATIONS

This application is a non-provisional application of and claims the benefit of priority from U.S. Provisional Application Ser. No. 61/444,234, entitled “Transaction Processing and Backup,” filed Feb. 18, 2011, which is incorporated herein by reference in its entirety.

### BACKGROUND

Availability of services to customers, particularly to customers of a financial institution, is a top priority. Customers expect to initiate a transaction, such as at an automated teller machine (ATM), online banking system, etc. and have the transaction completed. However, data centers at which transactions are processed may be unavailable due to outages or failures. These outages generally cause the type, amount, etc. of transactions available to a customer to be limited. For instance, if the data center designated to process transactions for a particular client is unavailable, that client may be limited to only certain types of transactions, or to transactions below a certain dollar amount until the data center is available. This can be inconvenient for a customer.

Further, an outage or failure of a data center may require a backup data center to be established using data recovered from the unavailable data center. This can take several hours and is often only initiated when the failure is catastrophic.

Accordingly, a system and method for providing uninterrupted transaction processing and/or backup data centers for processing transactions would be advantageous.

### SUMMARY

The following presents a simplified summary in order to provide a basic understanding of some aspects of the invention. The summary is not an extensive overview of the invention. It is neither intended to identify key or critical elements of the invention nor to delineate the scope of the invention. The following summary merely presents some concepts of the invention in a simplified form as a prelude to the description below.

According to one or more aspects, a system and method of providing uninterrupted transaction processing in the event of a failure or outage at a data center is provided. In some examples, the system or method may include receiving a request for a transaction. In some arrangements, a primary data center for processing that transaction may be identified. If the primary data center is available to process the transaction, the transaction may be processed and data associated with the processed transaction may be transmitted to one or more alternate or secondary data centers. If the primary data center is not available, the transaction may be routed to a secondary data center and processed at that data center. Data associated with the processed transaction may then be transmitted to the primary data center and any other secondary data centers. Accordingly, accurate, near real-time transaction data may be maintained at multiple data centers to permit transaction processing at multiple data centers.

### BRIEF DESCRIPTION OF THE DRAWINGS

The present disclosure is illustrated by way of example and not limited in the accompanying figures in which like reference numerals indicate similar elements.

FIG. 1 illustrates an example of a suitable operating environment in which various aspects of the disclosure may be implemented.

FIG. 2 illustrates an example system for processing transactions according to one or more aspects described herein.

FIG. 3 illustrates one example method of processing transactions according to one or more aspects described herein.

FIG. 4 illustrates another example method of processing transactions according to one or more aspects described herein.

FIG. 5 illustrates one example user interface for configuring data sampling to ensure data integrity according to one or more aspects described herein.

### DETAILED DESCRIPTION

In the following description of various illustrative embodiments, reference is made to the accompanying drawings, which form a part hereof, and in which is shown, by way of illustration, various embodiments in which the claimed subject matter may be practiced. It is to be understood that other embodiments may be utilized and structural and functional modifications may be made without departing from the scope of the present claimed subject matter.

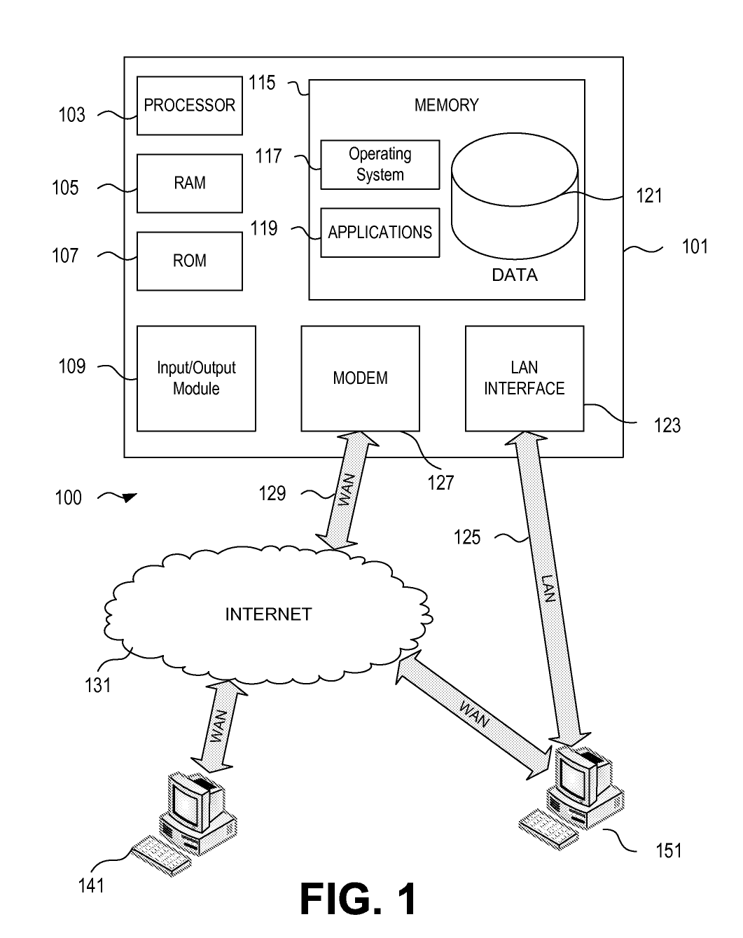

FIG. 1 illustrates a block diagram of a generic computing device 101 (e.g., a computer server) in computing environment 100 that may be used according to an illustrative embodiment of the disclosure. The computer server 101 may have a processor 103 for controlling overall operation of the server and its associated components, including random access memory (RAM) 105, read-only memory (ROM) 107, input/output (I/O) module 109, and memory 115.

I/O 109 may include a microphone, mouse, keypad, touch screen, scanner, optical reader, and/or stylus (or other input device(s)) through which a user of server 101 may provide input, and may also include one or more of a speaker for providing audio output and a video display device for providing textual, audiovisual and/or graphical output. Software may be stored within memory 115 and/or other storage to provide instructions to processor 103 for enabling server 101 to perform various functions. For example, memory 115 may store software used by the server 101, such as an operating system 117, application programs 119, and an associated database 121. Alternatively, some or all of server 101 computer executable instructions may be embodied in hardware or firmware (not shown).

The server 101 may operate in a networked environment supporting connections to one or more remote computers, such as terminals 141 and 151. The terminals 141 and 151 may be personal computers or servers that include many or all of the elements described above relative to the server 101. The network connections depicted in FIG. 1 include a local area network (LAN) 125 and a wide area network (WAN) 129, but may also include other networks. When used in a LAN networking environment, the computer 101 may be connected to the LAN 125 through a network interface or adapter 123. When used in a WAN networking environment, the server 101 may include a modem 127 or other network interface for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP, HTTPS, and the like is presumed.

Computing device 101 and/or terminals 141 or 151 may also be mobile terminals (e.g., mobile phones, PDAs, notebooks, etc.) including various other components, such as a battery, speaker, and antennas (not shown).

The disclosure is operational with numerous other general purpose or special purpose computing system environments or configurations. Examples of well known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The disclosure may be described in the general context of computer-executable instructions, such as program modules, being executed by one or more computers and/or one or more processors associated with the computers. Generally, program modules include routines, programs, objects, components, data structures, etc. that perform particular tasks or implement particular abstract data types. Aspects of the disclosure may also be practiced in distributed computing environments where tasks are performed by remote processing devices that are linked through a communications network. In a distributed computing environment, program modules may be located in both local and remote computer storage media including memory storage devices.

The above-described systems may be used in various businesses or corporate entities, such as financial institutions, as well as government organizations, universities, and other organizations. For instance, the systems and methods described herein may be used in any entity having multiple data centers or storing data at multiple cites. In some examples, the data may be processed at a primary data center and then transmitted to a secondary data center. This may aid in maintaining accurate data at all data centers in the event that one data center should be unavailable.

For example, a user may conduct a transaction at an automated teller machine (ATM) in a first geographic location. Transactions taking place in that geographic location may generally be processed at a primary data center. In some examples, the primary data center may be a preferred data center. If the primary data center is available, the transaction will be processed there and data from the transaction will be transmitted to a secondary data center in order to ensure near real-time data is accurate at all data centers. If the primary data center is not available, the transaction may be processed at the secondary data center that may, in some examples, be in a different geographic location from the primary data center, and the data may be transmitted to the primary data center when the primary data center is again available. This arrangement may aid in providing user services without interruption or limitation due to one or more data centers being unavailable.

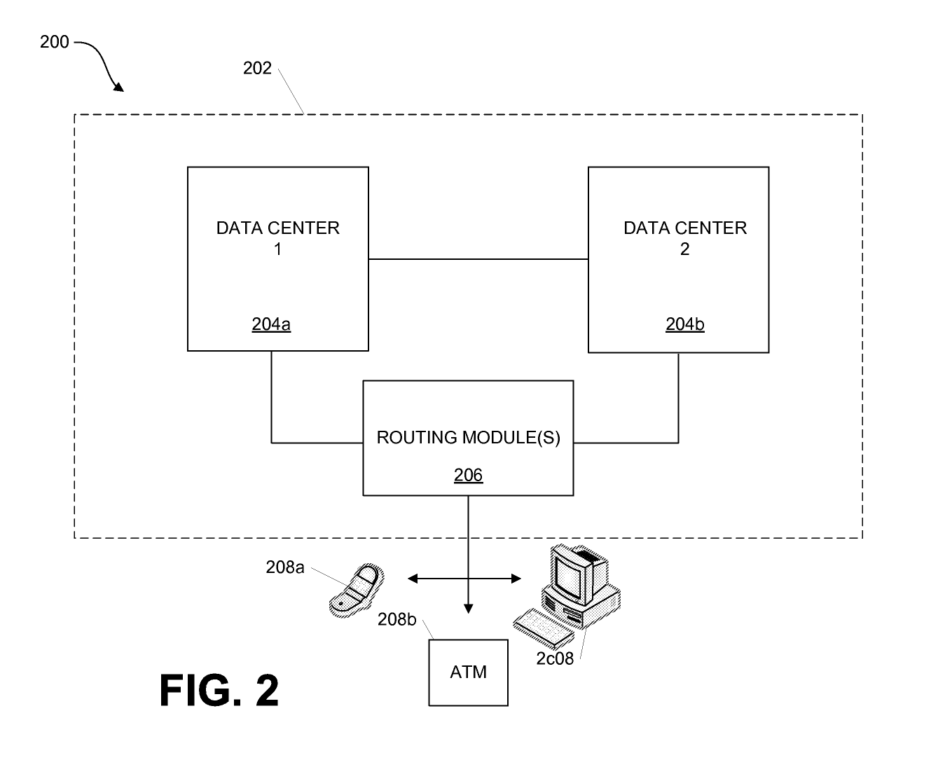

FIG. 2 illustrates one example system that may be used to process data and provide seamless services to a customer when one or more data centers is unavailable. The system 200 may include one or more data centers 204a, 204b. In some examples, the data centers may be internal to or part of the entity 202 implementing the system. For instance, if the system is being used by a financial institution 202, the one or more data centers 204a, 204b may be internal to the financial institution 202 or part of the financial institution 202. Alternatively, one or more data centers 204a, 204b may be external to the financial institution 202 (not shown). Further, the data centers 204a, 204b may be in different geographic locations. For instance, data center 1 204a may be in an eastern half of the U.S., while data center 2 204b may be in the western half of the U.S. The data centers 204a, 204b may be located virtually anywhere and may be any distance apart (e.g., 2 miles, 10, miles 1000 miles, 10000 miles, etc.). In some examples, the data centers may be at least 100 miles apart. In still other examples, the data centers may be at least 500 miles apart. Although two data centers 204a, 204b are shown in FIG. 2, more data centers may be used without departing from the invention.

Data centers 204a, 204b may house data associated with customers, customer transactions, and/or services provided to a customer. For instance, data centers 204a, 204b may house customer names, addresses, account numbers, etc., as well as transaction information such as deposits, withdrawals, and the like. In some examples, the data centers 204a, 204b may store data in hierarchically organized databases, such as those provided by IBM's INFORMATION MANAGEMENT SYSTEM. Additionally or alternatively, the data centers 204a, 204b may provide services such as authentication of a user (e.g., when logging on to an online banking system, when using an ATM card, etc.).

The data centers 204a, 204b may be connected to a routing module or modules 206. The routing module or modules 206 may receive a transaction or request for transaction from a customer and may route it to an appropriate data center 204a, 204b. For instance, in some examples, transactions may be processed based on the geographic location of the customer requesting the transaction (e.g., transactions requested in the eastern half of the U.S. may be processed at one data center, e.g., data center 1 204a, while transactions occurring in the western half of the U.S. may be processed at another data center, e.g., data center 2 204b). Additionally or alternatively, transactions may be processed at different data centers depending on a type of transaction, type of customer (e.g., personal or business), amount of transaction, etc. Accordingly, a transaction may be associated with a primary data center. Continuing the example above, if the requested transaction is occurring in the eastern half of the U.S., data center 1 204a would be identified as the primary data center for the transaction. Accordingly, any transaction occurring in that location, or any other location within the eastern half of the U.S. would, preferentially in one arrangement, be processed at data center 1 204a, and the transaction would be routed to data center 1 204a by the transaction processing module 206.

Once the transaction has been processed, data associated with the transaction may be transmitted from the primary data center (e.g., data center 1) to a secondary data center (e.g., data center 2). This arrangement may maintain updated, near real-time data at multiple or all data centers. Thus, in the event that the primary data center is unavailable for a transaction, the transaction may be routed to and processed at a secondary data center.

For instance, if, in the above-example, primary data center 1 204a was unavailable, the routing module(s) 206 may route the transaction to data center 2 204b, and the transaction may be processed at that data center 204b without any delay or limitation for the customer. For example, the transaction may be conducted in a similar amount of time and any suitable type of transaction may be processed by the secondary data center 204b. The maintenance or storage of data at both or all data centers 204a, 204b (e.g., the transmission of all data between the data centers after the transaction has been processed) may allow these transactions to be processed and may ensure that data integrity is maintained.

In some arrangements, a notification or command indicating that the primary data center is unavailable may be transmitted (e.g., to the transaction processing module 206) to indicate that a secondary data center should receive the transaction. In other examples, a transaction may attempt to route to the primary data center but may be unable due to the data center being unavailable. In this arrangement, the transaction may automatically be routed to the secondary data center after a predefined number of failed attempts.

In some conventional systems, if the primary data center is unavailable, the customer may have limitations in a type of transaction that may be performed (e.g., deposits only, etc.) or an amount of the transaction (e.g., less than $500, less than $300, etc.) until the primary data center again becomes available. In the case of a catastrophic failure of the primary data center, in conventional systems, an alternative data center may be recovered from backup data available. However, it may take several hours for the alternative data center to become available due to time required to recover data, etc. The arrangement described herein would not only allow a financial institution to reduce or eliminate the need for transaction limitations because the transaction data is available at and transmitted to all data centers, but would also provide seamless, uninterrupted service to customers, even during minor failures or system outages at a primary data center, because the data is immediately available and transactions can be processed at the secondary data center.

The system 200 may be connected to one or more user devices 208a-208c. Transactions may be initiated at one or more of the user devices, such as a cell phone or smart phone 208a, ATM 208b, or online banking system via computer 208c and processed as discussed above.

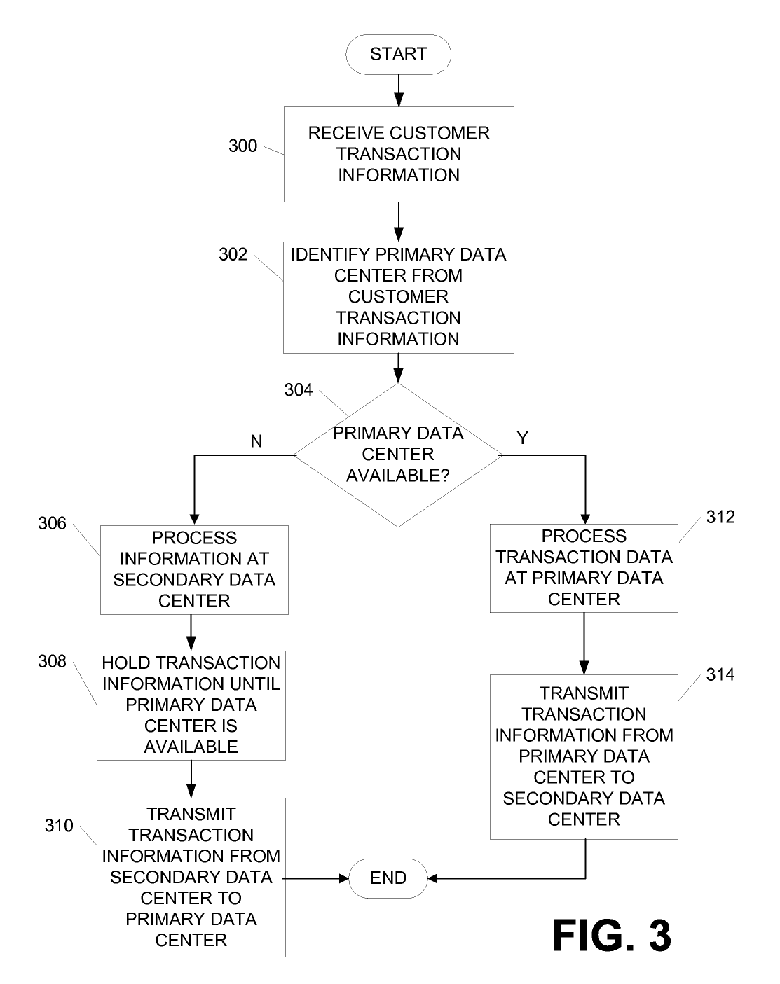

FIG. 3 illustrates one example method of processing transactions and backing up a data center. In step 300, customer transaction information is received. The customer transaction information may include customer identifier, type of transaction, amount of transaction, and the like. In step 302, a primary data center for processing the transaction may be identified based on the received customer transaction information. For instance, the primary data center may be identified based on the geographic location or region of the customer or of the requested transaction. As discussed above, various other factors for identifying a primary data center may be used without departing from the invention.

In step 304, a determination is made as to whether the identified primary data center is available. For instance, if the primary data center is experiencing an outage, failure, etc., the primary data center may not be available to process the transaction. If the primary data center is available in step 304, the transaction may be processed at the primary data center in step 312 and the transaction information associated with the processed transaction may be transmitted to one or more secondary data centers in step 314 (e.g., after the transaction is processed). Transmission to the one or more secondary data centers may include a customer identifier, type of transaction, amount of transaction, etc. In some arrangements, the transmitted data may be confirmed at the secondary data center to ensure accuracy, as will be discussed more fully below.

If, in step 304, the primary data center is not available to process the transaction, the transaction will be routed to a secondary data center in step 306 and processed at that second data center. Processing of the transaction, at either the primary data center or the secondary data center, might not be evident to the customer. That is, the customer may request the transaction and the transaction will be processed in a similar amount of time, with similar confirmation, etc. regardless of whether the primary or secondary data center is processing the transaction. Once the transaction has been processed in step 306, the transaction data may be held in step 308 until the primary data center is available. Once the primary data center is available, the transaction data from the transaction processed at the secondary data center will be transmitted to the primary data center in order to maintain accurate data at both data centers.

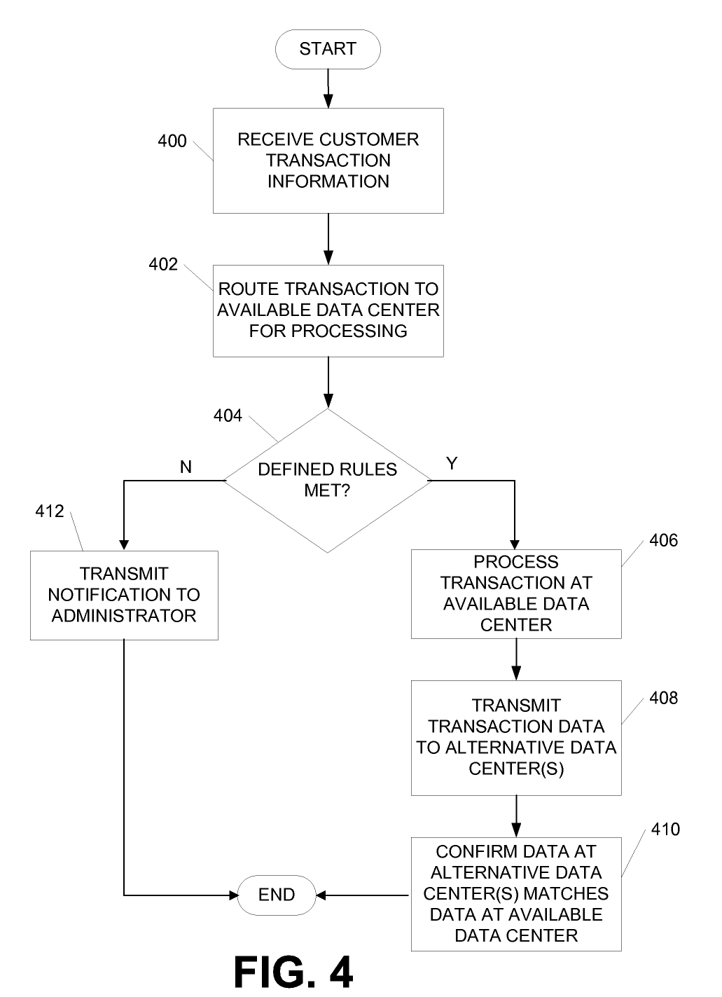

FIG. 4 illustrates another example method of processing transactions. In step 400, customer transaction data is received. In step 402, the transaction is routed to an available data center. This may be similar to steps 302-306 and/or 312 in FIG. 3. In step 404, a determination is made as to whether one or more rules associated with processing the transaction have been met. For instance, one or more rules may be established in order to prevent duplication of transactions, ensure data accuracy, etc. Further, one or more rules may be established in order to reduce instances of fraud or reduce risk to the financial institution. For instance, prior to processing the transaction, a confirmation of sufficient funds in a client account may be necessary. Although this is merely one example rule, various other rules may be established in order to aid in providing accurate transaction processing.

If, in step 404, the one or more rules have not been met, a notification may be sent to a system administrator and/or to the customer in step 412. For example, if the customer is requesting a withdrawal but does not have sufficient funds to cover the requested amount, a notification or potential overdraft may be sent to a system administrator and/or to the customer. In some examples, the transaction may then be cancelled.

Alternatively, if, in step 404, the one or more rules have been met, the transaction will be processed at the available data center in step 406. In step 408, data associated with the processed transaction may be transmitted to an alternate data center (e.g., a data center that was unavailable at the time of transaction, a secondary data center, etc.). In step 410, the integrity of the transmitted data may be confirmed. In some examples, the accuracy of the transaction data received may be compared with the transaction data at the data center that processed the request to ensure a match. Additionally or alternatively, periodic or aperiodic sampling of data at one or more data centers may be taken and matched against data at one or more other data centers. For instance, a percentage of data entries may be identified and compared with the corresponding data entries at another data center to ensure the data matches. Data sampling may be performed using known methods of sampling. Further, the sampling may be performed using software, hardware, etc. known, such as software available from SQDATA.

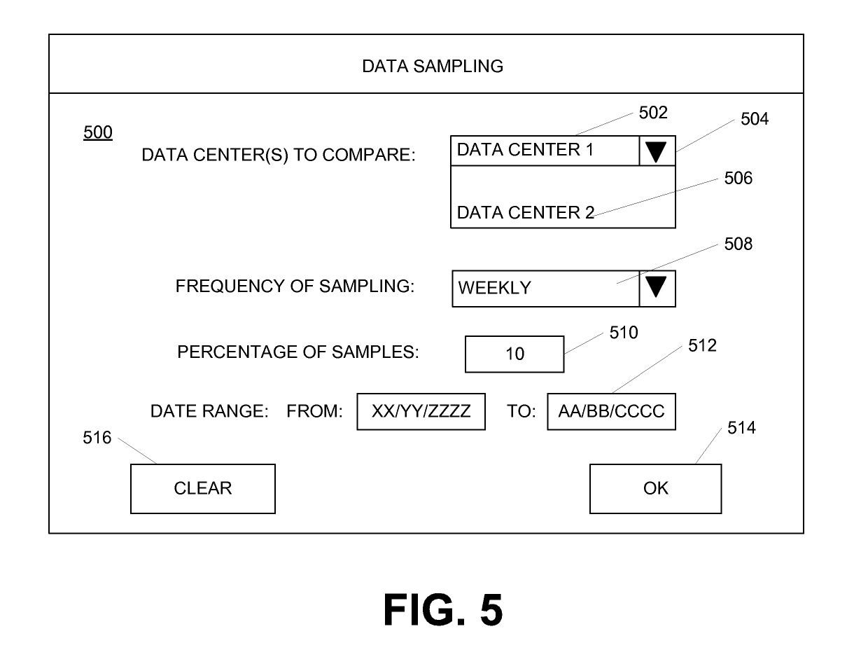

FIG. 5 illustrates one example user interface for configuring data sampling to ensure accuracy of data. The interface 500 may include a data center identification field 502. Field 502 may include one or more data centers at which a data sample should be taken. In some examples, the desired data center(s) may be selected from a drop-down menu 506 that may be provided upon selection of arrow 504. Selection of more than one data center may be performed using known methods of selection, such as holding the Ctrl key while selecting additional data center(s). Alternatively, the desired data centers may be typed into the field 502.

A frequency of sampling may be selected in field 508. The frequency may be daily, weekly, monthly, or may be on given dates in a month (e.g., 5^{th}, 10^{th}, 15^{th}, etc.). Alternatively, the sampling may be performed on an aperiodic basis or on-demand. A percentage of data to be sampled may be selected in field 510. For instance, 1%, 5%, 10%, etc. may be selected. In some examples, the percentage of data may be a percentage of data updated within a designated date range. For instance, a user may identify a desired date range in field 512 and the percentage of data sampled may be the percentage designated in field 510 of any data modified during the designated date range. Alternatively, the sample may be 100% of the data within a specified date range. Various other sampling selection arrangements may be used without departing from the invention. Selection of ok option 514 will process the settings in the fields described above, while selection of clear option 516 will clear the settings in those fields or, in some examples, may return the settings to default settings.

As discussed above, the storage of data at multiple data centers may allow for seamless, uninterrupted access to transactions for customers. Stated differently, if a primary data center associated with a customer is unavailable, the transaction may be processed (in a manner seemingly uninterrupted to the customer) at a secondary data center. Data from processed transactions may be transmitted to other data centers in order to maintain accurate, near real-time data at all data centers to enable processing of transactions at any available data center. Further, having the ability to process transactions at any available data center may enable the financial institution or other entity implementing the system to pre-plan maintenance outages, etc. with minimal disruption to services provided to customers.

The above-described systems and methods may be used with various hardware, software, etc. For instance, the systems and methods described above may be used with hierarchically organized databases, such as IBM's INFORMATION MANAGEMENT SYSTEM. However, the systems and methods may be used with various other hardware and software systems without departing from the invention.

The methods and features recited herein may further be implemented through any number of computer readable media that are able to store computer readable instructions. Examples of computer readable media that may be used include RAM, ROM, EEPROM, flash memory or other memory technology, CD-ROM, DVD, or other optical disc storage, magnetic cassettes, magnetic tape, magnetic storage and the like.

While illustrative systems and methods described herein embodying various aspects are shown, it will be understood by those skilled in the art that the invention is not limited to these embodiments. Modifications may be made by those skilled in the art, particularly in light of the foregoing teachings. For example, each of the elements of the aforementioned embodiments may be utilized alone or in combination or sub-combination with the elements in the other embodiments. It will also be appreciated and understood that modifications may be made without departing from the true spirit and scope of the present invention. The description is thus to be regarded as illustrative instead of restrictive on the present invention.

What is claimed is:

1. An apparatus comprising:
at least one processor; and
at least one memory having stored therein computer executable instructions, that when executed by the at least one processor, cause the apparatus to:
receive, by a transaction processing system, a request for a transaction;
identify, by the transaction processing system, a primary data center for processing the requested transaction;
determine, by the transaction processing system, whether the primary data center is available;
responsive to determining that the primary data center is available, process the transaction and transmit data associated with the processed transaction from the primary data center to a secondary data center; and
responsive to determining that the primary data center is not available, process the transaction at the secondary data center and transmit the data associated with the processed transaction from the secondary data center to the primary data center.

2. The apparatus of claim 1, wherein transmitting the data associated with the processed transaction from the secondary data center to the primary data center includes holding the data until the primary data center is available.

3. The apparatus of claim 1, wherein the primary data center is a preferred data center for a customer associated with the requested transaction.

4. The apparatus of claim 1, wherein identifying the primary data center includes identifying the primary data center based on a geographic location of the requested transaction.

5. The apparatus of claim 1, wherein identifying the primary data center includes identifying the primary data center based on a geographic location of a customer associated with the requested transaction.

6. The apparatus of claim 1, wherein the data center at which the transaction is processed is not evident to a customer requesting the transaction.

7. The apparatus of claim 1, wherein processing the transaction at the second data center includes processing any type of transaction processed at the primary data center when the primary data center is available.

8. A method, comprising:
receiving, by a transaction processing system, a request for a transaction;
identifying, by the transaction processing system, a primary data center for processing the requested transaction;
determining, by the transaction processing system, whether the primary data center is available;
responsive to determining that the primary data center is available, processing the transaction and transmitting data associated with the processed transaction from the primary data center to a secondary data center; and
responsive to determining that the primary data center is not available, processing the transaction at the secondary data center and transmitting the data associated with the processed transaction from the secondary data center to the primary data center.

9. The method of claim 8, wherein transmitting the data associated with the processed transaction from the secondary data center to the primary data center includes holding the data until the primary data center is available.

10. The method of claim 8, wherein the primary data center is a preferred data center for a customer associated with the requested transaction.

11. The method of claim 8, wherein identifying the primary data center includes identifying the primary data center based on a geographic location of the requested transaction.

12. The method of claim 8, wherein identifying the primary data center includes identifying the primary data center based on a geographic location of a customer associated with the requested transaction.

13. The method of claim 8, wherein the data center at which the transaction is processed is not evident to a customer requesting the transaction.

14. The method of claim 8, wherein processing the transaction at the second data center includes processing any type of transaction processed at the primary data center when the primary data center is available.

15. One or more non-transitory computer-readable media storing computer-readable instructions that, when executed by at least one computer, cause the at least one computer to:
receive, by a transaction processing system, a request for a transaction;
identify, by the transaction processing system, a primary data center for processing the requested transaction;
determine, by the transaction processing system, whether the primary data center is available;
responsive to determining that the primary data center is available, process the transaction and transmit data associated with the processed transaction from the primary data center to a secondary data center; and
responsive to determining that the primary data center is not available, process the transaction at the secondary data center and transmit the data associated with the processed transaction from the secondary data center to the primary data center.

16. The apparatus of claim 15, wherein transmitting the data associated with the processed transaction from the secondary data center to the primary data center includes holding the data until the primary data center is available.

17. The apparatus of claim 15, wherein the primary data center is a preferred data center for a customer associated with the requested transaction.

18. The apparatus of claim 15, wherein identifying the primary data center includes identifying the primary data center based on a geographic location of the requested transaction.

19. The apparatus of claim 15, wherein identifying the primary data center includes identifying the primary data center based on a geographic location of a customer associated with the requested transaction.

20. The apparatus of claim 15, wherein the data center at which the transaction is processed is not evident to a customer requesting the transaction.

21. The apparatus of claim 15, wherein processing the transaction at the second data center includes processing any type of transaction processed at the primary data center when the primary data center is available.
